(19) United States
(12) Patent Application Publication
(10) Pub. No.: US 2015/0269675 A1
(43) Pub. Date: Sep. 24, 2015

(54) TRADE-TIME CREDIT CHECK SYSTEM AND METHODS

(71) Applicant: Goldman, Sachs & Co., New York, NY (US)

(72) Inventor: Paul Walker, New York, NY (US)

(21) Appl. No.: 14/662,517

(22) Filed: Mar. 19, 2015

Related U.S. Application Data
(60) Provisional application No. 61/968,122, filed on Mar. 20, 2014.

(51) Int. Cl. G06Q 40/04

(52) U.S. Cl. CPC G06Q 40/04

(57) ABSTRACT

System and methods for performing trade-time credit checks to guarantee the availability of credit to clear and settle trades for market participants are disclosed. In one embodiment, an order to buy or sell an amount of a financial instrument is received by the system. The system then determines an amount of a credit support financial instrument available for the market participant. The credit support financial instrument is a synthetically created financial instrument that is issued on an exchange for a market participant. The system then determines whether the amount of the credit support financial instrument available is enough to cover the order and if so, the system executes the order. The system then depletes the amount of the credit support financial instrument available for a subsequent trade by the amount of the executed trade to reflect the reduction in availability of credit for subsequent trades.

### CROSS REFERENCE TO RELATED APPLICATIONS

This application claims priority to and benefit from U.S. Provisional Patent Application No. 61/968,122 titled “Trade-Time Credit Check System And Methods” filed on Mar. 20, 2014, which is incorporated herein by reference for all purposes.

### FIELD OF THE DISCLOSURE

The present disclosure generally relates to financial markets and to system, methods and computer program products for operating securities exchanges. More particularly, embodiments of the present invention relate to monitoring credit of traders.

### BACKGROUND

Exchanges act as centralized market places where individuals and institutions can trade securities (e.g., stocks, bonds, forwards, futures, options, swaps, etc.). Further, the entity operating the exchange provides the facilities and services for brokers and traders to trade such securities.

Historically, human traders executed trades where a first trader represented the seller and a second trader represented the buyer. As trading volume increased, however, trading largely moved to electronic platforms where trades are automatically completed by sophisticated, computerized systems. Thus, at present, the financial markets depend on efficient execution of trades to buy and sell securities (e.g., equities such as common stock).

As part of any trade—whether a broker-to-broker trade or institutional trade performed by an investment manager for a mutual fund, hedge fund, pension fund, investment bank, etc.—there are clearing and settlement processes. That is, after the trade is executed, a clearing process is performed involving reporting, monitoring, risk margining, netting of trades to single positions, tax handling, and failure handling. Then, the trade undergoes a settlement process where the delivery requirements of the payment and the securities underlying the trade are delivered to the respective parties. That is, cash is received from the buyer and securities received from the seller and, at the end of the process, the securities are delivered to the buyer and the cash delivered to the seller.

The above-described clearing and settlement process is typically performed by one or more entities (i.e., each a “clearing house”) separate and apart from the entity that operates the securities exchange. The clearing houses are essentially charged with performing the function of ensuring the trustworthiness or creditworthiness of the traders on the exchange. Many traders are represented to a clearing house by a separate commercial entity, the “clearing broker” who extends credit to the ultimate client and settles trades on their behalf. Credit checks on the traders is typically conducted by the clearing house/broker before the traders become clearing house members or participants, and are often refreshed for the start of a trading session. However, such pre-membership credit checks do not provide the exchange a real-time or current view of the actual credit available to traders and thus fails to prevent the exchange from executing trades between trading counterparties that may fail to settle. For example, even if all parties of a trade passed their respective pre-membership or start of day or even regular pre-order credit checks performed by the clearing house/broker, after the trade is executed by the exchange, it may be the case that one or more of the parties to the trade do not have the credit and funds to settle a ‘good’ trade. This failure to settle the trade can cause losses in other parts of the financial system, either the clearing broker, executing counterpart, or clearing house.

### BRIEF DESCRIPTION OF THE DRAWINGS

FIG. 1 shows an example environment in which the system and methods of performing trade-time credit check can be implemented.

FIG. 2 shows a diagrammatic representation of a machine in the example form of a computer system within which a set of instructions, for causing the machine to perform any one or more of the methodologies discussed herein, may be executed.

FIG. 3 shows a flow diagram of various steps implemented in a pre-trade credit check system, according to an embodiment of the present disclosure.

### DETAILED DESCRIPTION

Embodiments of the present disclosure overcome the disadvantages of the existing method of extending credit by providing an exchange with a trade-time credit check mechanism that allows the exchange to locally check a trader's credit availability for a trade and execute or block the trade based on availability of the credit. The exchange can perform the credit check on a trade by trade basis and without communicating with other parties such as the issuers of the credit. In one embodiment, the exchange can determine a trader's credit availability by determining the amount of synthetic credit support securities that the trader has. In one embodiment, when the trader does not have enough credit to settle a trade, the exchange can block the trade from occurring. Similarly, when the trader trader has sufficient credit to settle a trade, the exchange can allow the trade to proceed. Thus, the credit checking in accordance with the present disclosure occurs at the exchange well before the conventional clearing house's clearing and settlement processes and, before the trade is executed by the exchange. The trade-time credit checks as disclosed herein are performed to guarantee the availability of credit to settle trades for market participants and avoid losses that can result from failure to settle trades due to insufficient credit.

In one embodiment of the present disclosure, an exchange tracks credit availability for traders using synthetic credit support securities. In one embodiment, a credit support security having its own ticker symbol is created for a security that trades in an exchange. At the beginning of a trading day, a client starts with an amount of the credit support security (e.g., $1MM) that the client can use as available credit to settle trades on the exchange. As the trading day progresses, the client may place one or more orders for the exchange to execute. Prior to executing any order, the exchange checks that the client has enough shares of the credit support security available to execute the order. If the client has enough shares, the exchange executes the order and adjusts (or depletes) the amount of shares of the credit support available for future orders on the same trade day. If a subsequent order is placed on the same day, the exchange once again checks whether the remaining amount of the credit support available to the client is enough to execute the order, and proceeds or blocks execution of the order accordingly.

In another embodiment of the present disclosure, at least two credit support securities, each of which is denoted by its own ticker symbol, are created. A client begins a trading day with a first amount of the credit support security for long trades and a second amount of the credit support security for short trades. The exchange checks these amounts of the long and short credit support securities before a trade occurs and approves or blocks the execution of the trade. If the trade proceeds to execution, the exchange adjusts these amounts to reflect the decreased availability of credit for subsequent trades on the same day.

In one embodiment, a credit support security distinguished by its ticker symbol is associated with a tradable security. In some embodiments, credit support securities are differentiated by underlying currency, for multi-currency trading venues. For example, if an exchange deals with US dollars and Euros, separate credit support securities for US dollars and Euros can be created for trade-time credit checks. In some embodiments, credit support securities can be offered by one client to support the trading of another where no clearing relationship is available, to allow short term trading support.

Various implementations of the present disclosure that includes system, methods and computer program products for performing trade-time credit checks will now be described. Although the present disclosure is described in terms of trading the common stock of a fictitious, large-cap XYZ Corporation in US dollars ($) listed and traded on a stock exchange, it should be understood that this is for illustration purposes only and not intended to denote any limitations of the present disclosure. For example, embodiments of the present disclosure can be applicable to, and/or implemented (with or without modifications) in a plurality of trading venues including exchanges and other over-the-counter markets, swap-execution facilities, and/or the like in the execution of a plurality of financial instruments including securities, options, futures, other derivatives, debt instruments such as bonds, and/or the like an in various currencies such as US dollars, Euros, Yen, Pounds, Canadian dollars, Renminbi, and/or the like.

Further, the following description provides specific details for a thorough understanding and an enabling description of these implementations. One skilled in the art will understand, however, that the disclosed systems, methods and computer program products may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations.

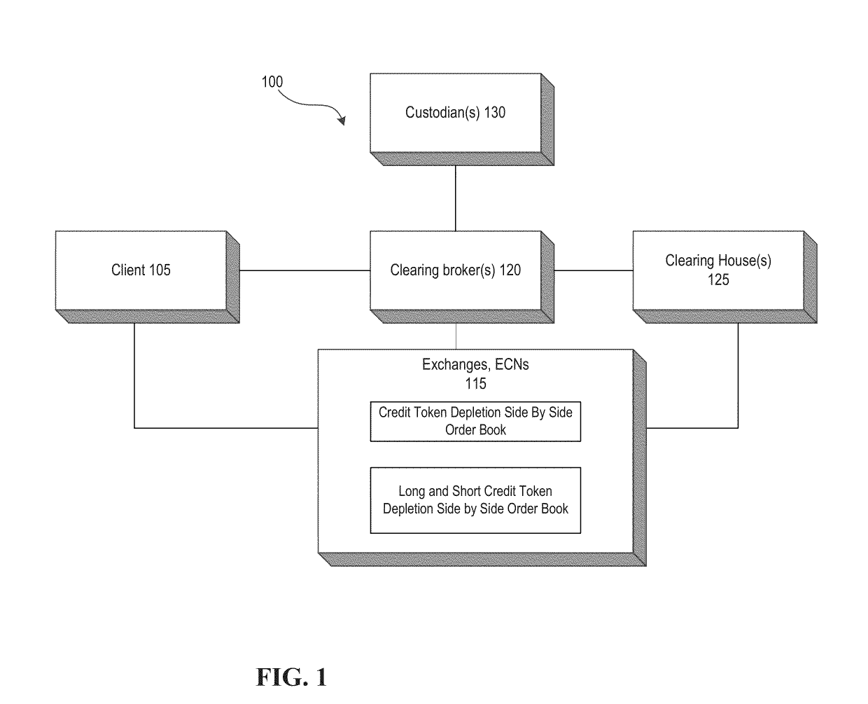

The disclosed embodiments can be implemented in an environment such as the one depicted in FIG. 1. As shown, the environment 100 includes a client 110 who wishes to buy/sell financial instruments. The client 105 submits orders to the appropriate exchange 115 which can include an exchange (e.g., New York Stock Exchange), an electronic crossing network (ECN), and/or other execution facilities. The exchange 115 can, in one embodiment, maintain the disclosed credit token depletion order book and/or long and short credit token depletion order book and perform trade-time credit check on the order(s) prior to executing the order as described in detail below. The exchange 115 either executes or blocks the trade depending on the amount of credit support securities available determined as part of the trade-time credit check. If the trade-time credit check is successful, the order is executed at the exchange 115 and the execution report is sent to the client 105. The executed trade is cleared by the clearing house 125. The clearing broker 120 or in the case that the client 105 is a self-clearing entity, the client 105 facilitates clearing of the trade and communicates with the custodian 130 regarding the financial instruments expected to be received or required to be delivered.

### 1. Single Currency Equivalent (e.g., USD)

In one embodiment, an exchange implements a “credit token depletion side-by-side order book” mechanism, via a computer, to perform trade-time credit checks. For each client (C) trading on the exchange, the exchange creates a “synthetic” credit support security which is denoted by its ticker) symbol “*S[C]”. At the beginning of each trading day, the clearing broker for client C (or C themselves if they are a self-clearing entity) issues a trade order associated with the synthetic credit support security on the exchange in the format of:

“Sell Q*S[C] at 0USD”

where Q is the daily dollar volume (e.g., $1000,000) of credit available for C to settle trades on that exchange.

As the trading day proceeds, C desires to purchase 1000 shares of XYZ, which are currently trading at $100/share. C places an order, and subsequently receives an execution from the exchange. The standard execution of cash for securities, which will clear in the future would be as follows:

+1000 XYZ

−100,000 USD

Instead of the standard execution shown above, the exchange, in an embodiment, modifies this transaction such that, in addition to constructing an obligation to deliver 100,000 USD, the posted credit availability of the client is depleted. That is, the above execution is modified to:

+1000 XYZ

−100,000 USD

−100,000*S[C].

Thus a real-time post-trade view of the consumed credit is available at the exchange. The exchange can block the matching of or acceptance of an order if there are not enough *S[C] shares available.

By way of another example, consider an order for 100,000 units of XYZ placed on an exchange. This order implies an execution of:

+100,000 XYZ

−10,000,000 USD

−10,000,000*S[C]

But such an execution would imply a negative balance of *S[C] (since it was created in the morning with 1,000,000 units). This execution would not occur in the exchange because there are not enough *S[C] shares available. In this situation, if C desires to halt all trading from its accounts during a certain day, it can simply cancel the outstanding position on *S[C] by issuing an offsetting buy, or by cancelling the standing sell order.

### 2. Long Short Currency Equivalent Pair (e.g., USD)

In another embodiment of the present disclosure, an exchange implements a “long and short credit token depletion side-by-side order book” mechanism, via a computer, to facilitate trade-time credit checks. For each client (C) trading on the exchange, the exchange creates two “synthetic” credit securities, denoted by example (ticker) symbols “*S_L[C]” and “*S_S [C]”.

At the beginning of each trading day, the clearing house for C (or C themselves if they are a self-clearing entity) issues a trade order on the exchange in the format of:

“Sell Q1*S_L[C] at 0USD”

“Sell Q2*S_S[C] at 0USD”

where Q1 is the daily dollar volume (e.g., $1M) of long trades for C; and where Q2 is the daily dollar volume (e.g., $1M) of short trades for C. In other words, a long and short USD equivalent pair allows C to blend on a gross USD basis.

In this model, the security required to offset the dollar gain from a short sell is distinct from the security required to fund the dollar spend for a long sale.

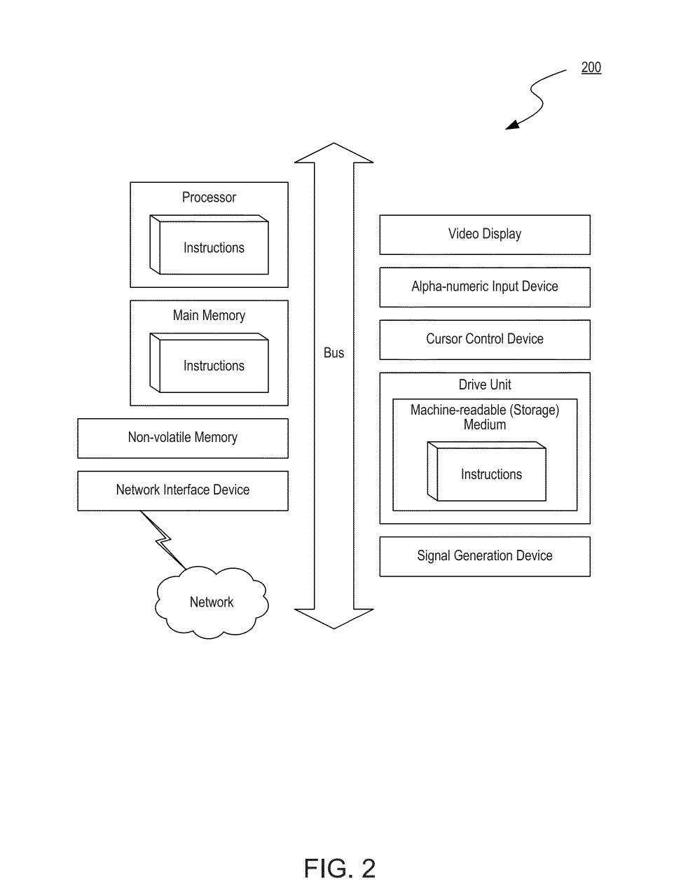

Aspects, embodiments and implementations of the disclosed system and methods for performing trade-time credit checks have been described in the general context of computer-executable instructions, such as routines executed by a general-purpose computer, a personal computer, a server, or other computing systems. FIG. 2 shows a diagrammatic representation of a machine in the example form of a computer system within which a set of instructions, for causing the machine to perform any one or more of the methodologies discussed herein, may be executed.

In the example of FIG. 2, the computer system 200 includes a processor, main memory, non-volatile memory, and an interface device. Various common components (e.g., cache memory) are omitted for illustrative simplicity. The computer system 200 is intended to illustrate a hardware device on which any of the components depicted in the example of FIG. 1 (and any other components described in this specification) can be implemented. The computer system 200 can be of any applicable known or convenient type. The components of the computer system 200 can be coupled together via a bus or through some other known or convenient device.

The processor may be, for example, a conventional microprocessor such as an Intel Pentium microprocessor or Motorola power PC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer 200. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache. Ideally, this serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system. The interface can include an analog modem, isdn modem, cable modem, token ring interface, satellite transmission interface (e.g., “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 10 reside in the interface.

In operation, the computer system 200 can be controlled by operating system software that includes a file management system, such as a disk operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device that manipulates and transforms data represented as physical (electronic) quantities within the computer system's registers and memories into other data similarly represented as physical quantities within the computer system memories or registers or other such information storage, transmission, or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, may be implemented as part of an operating system or a specific application, component, program, object, module, or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

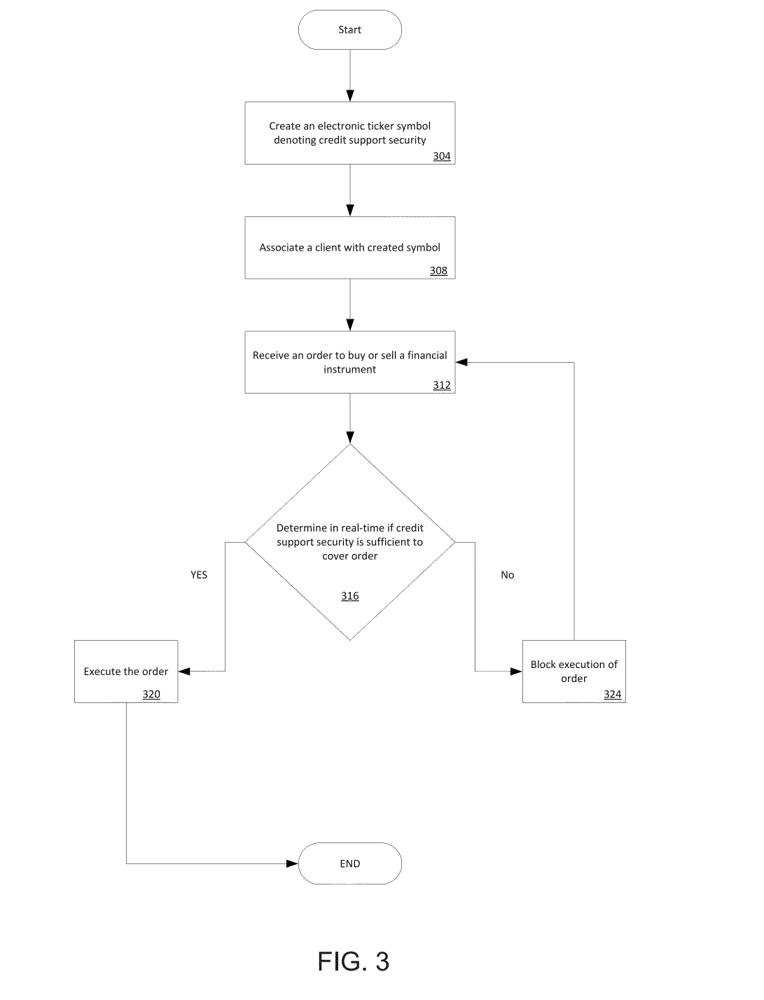

Now referring to FIG. 3, various steps are shown as implemented in a pre-trade credit check system, according to an embodiment of the present disclosure. Starting at step 304, the system creates an electronic ticker symbol denoting credit support security. At step 308, the system associates a client with the created electronic ticker symbol. For example, if a client (C) is trading on the exchange, the exchange creates a “synthetic” credit support security which is denoted by a ticker symbol “*S[C].” At step 312, the system receives an order to buy or sell a financial instrument. Accordingly, at step 316, the system determines, in real-time if the credit support security is sufficient to cover the order. If the credit support security is sufficient to cover the order, then system executes the order at step 320. If, however, the credit support security is not sufficient to cover the order, then the system blocks execution of the order.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

What is claimed is:

1. A computer system implemented method for performing a trade-time credit check to facilitate clearing and settlement of a trade for market participants, comprising:
receiving at a computer system at an exchange an order from a market participant to buy or sell an amount of a financial instrument;
determining an amount of a credit support financial instrument available for the market participant;
determining whether the amount of the credit support financial instrument available is enough to cover the order;
when the amount of the credit support financial instrument is sufficient to cover the order, executing the order; and
when the amount of the credit support financial instrument is insufficient to cover the order, blocking the order from execution.

2. The method of claim 1, further comprising depleting the amount of the credit support financial instrument available for the market participant for a subsequent order by the amount of the financial instrument associated with the executed order such that the subsequent order is executed only when the depleted amount of the credit support financial instrument is able to cover the subsequent order.

3. The method of claim 2, wherein the credit support financial instrument is created by the exchange and is associated with a ticker symbol.

4. The method of claim 3, wherein an initial amount of the credit support financial instrument is issued as a trade order on the exchange by a clearing broker.

5. A computer-implemented method for performing a credit check at an execution venue to guarantee availability of credit to settle trades for market participants, comprising:
performing, by a computer, locally at the execution venue and prior to executing a trade, a credit check on a market participant to determine the market participant's credit availability for settling the trade; and
based on the credit availability for settling the trade, executing the trade or blocking execution of the trade at the execution venue.

6. The computer-implemented method of claim 5, wherein the execution venue is an exchange or an electronic communication network (ECN).

7. The computer-implemented method of claim 6, wherein the exchange or the ECN creates the synthetic security and a ticker symbol for the synthetic security.

8. The computer-implemented method of claim 7, wherein at the start of a trading period, the exchange or the ECN receives a trade order for an initial amount of the synthetic security corresponding to credit availability for the market participant.

9. The computer-implemented method of claim 8, wherein the initial amount of the synthetic security is depleted as one or more trades corresponding to the market participant occur.

10. The computer-implemented method of claim 9, wherein the trade is executed at the execution venue when an amount of the synthetic security available to the market participant is sufficient to settle the trade.

11. The computer-implemented method of claim 9, wherein the trade is blocked at the execution venue when an amount of the synthetic security available to the market participant is insufficient to settle the trade.

12. The computer-implemented method of claim 5, wherein the credit check is performed at the execution venue using information maintained at the execution venue.

13. The computer-implemented method of claim 5, wherein the exchange performs the credit check on the market participant a trade by trade basis.

14. The computer-implemented method of claim 5, wherein the exchange performs the credit check on the market participant without communicating with other parties.
